(19) United States
(12) Patent Application Publication
(10) Pub. No.: US 2024/0288698 A1
(43) Pub. Date: Aug. 29, 2024

(54) Electronic Devices with User-Specific Models

(71) Applicant: Apple Inc., Cupertino, CA (US)

(72) Inventors: Shannon Pomeroy, San Francisco, CA (US); Xiani Tan, Cupertino, CA (US)

(21) Appl. No.: 18/410,394

(22) Filed: Jan. 11, 2024

Related U.S. Application Data
(60) Provisional application No. 63/487,519, filed on Feb. 28, 2023.

(51) Int. Cl. G02B 27/01

(52) U.S. Cl. CPC G02B 27/0179; G02B 27/0172; G02B 2027/0138; G02B 2027/014; G02B 2027/0187

(57) ABSTRACT

A head-mounted device may include optical assemblies for presenting images to a user. The optical assemblies may be movable relative to one another. The head-mounted device may store a user-specific model for determining a distance between the optical assemblies and the user's face during operation of the head-mounted device. The user-specific model may predict when the distance between the optical assemblies and the user's face is too small based on measured input variables such as interpupillary distance, eye relief distance, vertical pupil position, and/or device tilt. The user-specific model may be generated based on a measured or inferred geometry of the user's nose and/or face. The user-specific model may be based on a face scan captured by a three-dimensional camera in the head-mounted device or in a separate electronic device.

This application claims the benefit of patent application No. 63/487,519, filed Feb. 28, 2023, which is hereby incorporated by reference herein in its entirety.

### FIELD

This relates generally to electronic devices and, more particularly, to electronic devices such as head-mounted devices.

### BACKGROUND

Electronic devices have components such as displays and lenses. It can be challenging to customize such devices for different users.

### SUMMARY

A head-mounted device may include optical assemblies for presenting images to a user. Each optical assembly may have a display and a lens through which an image from the display may be presented to a respective eye box.

Motors may be used to adjust the spacing between the optical assemblies to accommodate different user interpupillary distances. Gaze trackers may be used to measure the eyes of a user to determine target positions for the optical assemblies.

The head-mounted device may store one or more user-specific models. A user-specific model may be used to determine a distance between the optical assemblies and the face of the user. The user-specific model may predict when the distance between the optical assemblies and the user's face is too small (e.g., leading to compromised display performance or a less than optimal field of view) based on measured input variables such as interpupillary distance, eye relief distance, vertical pupil position, and/or device tilt. The user-specific model may be generated based on a measured or inferred geometry of the user's nose and/or face. The user-specific model may be based on a face scan captured by a three-dimensional camera in the head-mounted device or in a separate electronic device.

### BRIEF DESCRIPTION OF THE DRAWINGS

FIG. 1 is a diagram of an illustrative head-mounted device in accordance with some embodiments.

FIG. 2 is a diagram of an illustrative electronic device capturing face information from a face in accordance with some embodiments.

FIG. 3 is a diagram showing illustrative pupil positions and nose position relative to optical assemblies for a first nose geometry in accordance with some embodiments.

FIG. 4 is a diagram showing illustrative pupil positions and nose position relative to optical assemblies for a second nose geometry in accordance with some embodiments.

FIG. 5 is a diagram showing an illustrative vertical pupil position and eye relief distance relative to an optical assembly in accordance with some embodiments.

FIG. 6 is a graph showing an illustrative user-specific model for assessing whether optical assemblies are appropriately positioned for a first nose geometry in accordance with some embodiments.

FIG. 7 is a graph showing an illustrative user-specific model for assessing whether optical assemblies are appropriately positioned for a second nose geometry in accordance with some embodiments.

FIG. 8 is a flow chart of illustrative steps involved in generating a user-specific model in accordance with some embodiments.

FIG. 9 is a flow chart of illustrative steps involved in assessing whether optical assemblies are appropriately positioned during operation of a head-mounted device using a user-specific model in accordance with some embodiments.

### DETAILED DESCRIPTION

Electronic devices such as head-mounted devices may have displays for displaying images and lenses that are used in presenting the images to eye boxes for viewing by a user. Different users have different spacings between their eyes, which are sometimes referred to as interpupillary distances. To accommodate users with different interpupillary distances, a head-mounted device may be provided with movable optical assemblies.

Care must be taken when the positions of optical assemblies are adjusted relative to a user's face. Changes in eye relief distance, interpupillary distance, vertical pupil height, and device tilt, whether these changes are a result of user-made adjustments or system-made adjustments, can lead to a decreased distance between the user's face and the optical assemblies. If the distance between the user's face and the optical assemblies is less than a given threshold, the user's field of view may be reduced and/or display performance may be compromised. Different users may be at different distances from the optical assemblies depending on the user's specific nose and face geometry.

To reduce the risk of comprised display performance and/or unsatisfactory field of view resulting from an excessively small distance between the user's face or nose and the optical assemblies, a head-mounted device may implement a user-specific model to assess whether optical assemblies are appropriately positioned a given user. In some arrangements, the user-specific model may be generated based the user's actual face and nose geometry. For example, a camera in the head-mounted device and/or in a separate electronic device (e.g., a cellular telephone, tablet computer, etc.) may capture a three-dimensional face scan from which the user's nose geometry can be extracted. The face scan may be captured during an initial user enrollment process (e.g., when a user purchases a custom light seal for the head-mounted device) and/or may be captured at any other time (e.g., when switching between users). In other arrangements, the user-specific model may be generated based on inferred face and nose geometry. For example, the user's face and nose geometry may be inferred based on one or more user studies of typical face and nose geometries. Minimal user information such as eye color, interpupillary distance, and/or other measured user information may be used to help infer the user's face and nose geometry based on user studies of typical face and nose geometries.

The user-specific model may be used to assess whether the optical assemblies are appropriately positioned in real-time during operation of the head-mounted device. Real-time measurements of the positions of the user's pupils relative to the optical assemblies may be gathered during operation of the head-mounted device. For example, eye relief distance, interpupillary distance, vertical pupil position, and/or device tilt may be measured during operation of the head-mounted device by a gaze tracking system, inertial measurement unit, and/or other sensor. These measurements may be fed to the user-specific model and may be mapped to a distance value and/or an acceptability level. The acceptability level may be a binary value (e.g., acceptable or not acceptable), may be one of several acceptability categories (e.g., acceptable, moderately acceptable, or not acceptable), may be a value ranging from zero to one (e.g., with one indicating that the position is not acceptable and zero indicating that the position is acceptable), and/or may have other values. The acceptability level may indicate whether the distance between the user's face and the optical assemblies is less than a given threshold distance (e.g., zero or a non-zero threshold distance). For example, a “not acceptable” optical assembly position may indicate that the distance between optical assemblies 20 and the user's face is less than a threshold (e.g., the optical assemblies 20 are too close to the face), whereas an “acceptable” optical assembly position may indicate that the distance between optical assemblies 20 and the user's face is greater than a threshold (e.g., the optical assemblies 20 are far enough away from the user's face to avoid compromised display performance and reduced field of view).

Control circuitry in the head-mounted device may take action based on the determined distance or acceptability level. For example, the control circuitry may output an alert (e.g., an alert indicating that the optical assemblies are too close to the user's face and/or whether the user can improve display performance or increase field of view by making one or more adjustments to the head-mounted device), may automatically make one or more adjustments to increase the distance between the optical assemblies and the user (e.g., adjustments to eye relief distance, interpupillary distance, vertical pupil position, and/or device tilt), may output instructions to insert a shim or switch light seals in the head-mounted device, may lock/prevent further adjustments to the optical assemblies, and/or may take other actions based on the determined acceptability level of the optical assembly position. Optical assembly positions may be assessed continuously throughout use of the head-mounted device, may be assessed at predetermined times or intervals (e.g., when the head-mounted device is first placed on the user's head, when the head-mounted device is switched between users, when a motion sensor or other sensor in the head-mounted device detects a shift in position of the optical assemblies relative to the user's pupils or face, etc.), and/or may be assessed at any other suitable time (e.g., in response to user input, sensor data, etc.).

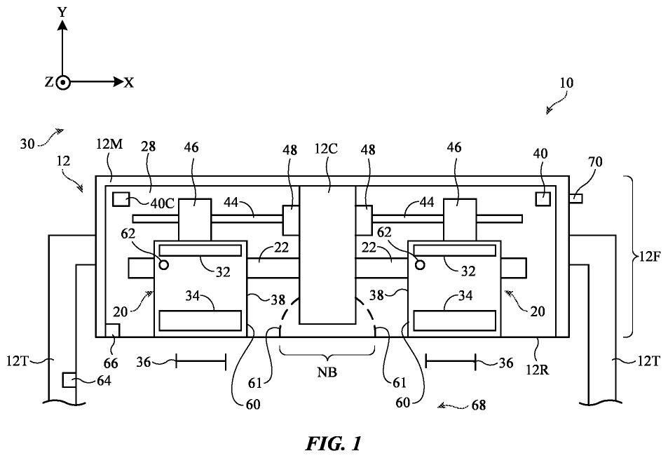

FIG. 1 is a schematic diagram of an illustrative electronic device of the type that may include movable optical assemblies (e.g., to accommodate different interpupillary distances). Device 10 of FIG. 1 may be a head-mounted device (e.g., goggles, glasses, a helmet, and/or other head-mounted device). In an illustrative configuration, device 10 is a head-mounted device such as a pair of goggles (sometimes referred to as virtual reality goggles, mixed reality goggles, augmented reality glasses, etc.).

As shown in the illustrative cross-sectional top view of device 10 of FIG. 1, device 10 may have a housing such as housing 12 (sometimes referred to as a head-mounted support structure, head-mounted housing, or head-mounted support). Housing 12 may include a front portion such as front portion 12F and a rear portion such as rear portion 12R. When device 10 is worn on the head of a user, rear portion 12R rests against the face of the user and helps block stray light from reaching the eyes of the user and nose bridge portion NB of housing 12 rests on the nose of the user.

Main portion 12M of housing 12 may be attached to head strap 12T. Head strap 12T may be used to help mount main portion 12 on the head and face of a user. Main portion 12M may have a rigid shell formed from housing walls of polymer, glass, metal, and/or other materials. When housing 12 is being worn on the head of a user, the front of housing 12 may face outwardly away from the user, the rear of housing 12 (and rear portion 12R) may face towards the user. In this configuration, rear portion 12R may face the user's eyes located in eye boxes 36.

Device 10 may have electrical and optical components that are used in displaying images to eye boxes 36 when device 10 is being worn. These components may include left and right optical assemblies 20 (sometimes referred to as optical modules). Each optical assembly 20 may have an optical assembly support 38 (sometimes referred to as a lens barrel, optical module support, or support structure) and guide rails 22 along which optical assemblies 20 may slide to adjust optical-assembly-to-optical-assembly separation to accommodate different user interpupillary distances.

Each assembly 20 may have a display 32 that has an array of pixels for displaying images and a lens 34. Lens 34 may optionally have a removable vision correction lens for correcting user vision defects (e.g., refractive errors such as nearsightedness, farsightedness, and/or astigmatism). In each assembly 20, display 32 and lens 34 may be coupled to and supported by support 38. During operation, images displayed by displays 32 may be presented to eye boxes 36 through lenses 34 for viewing by the user.

Rear portion 12R may include flexible structures (e.g., a flexible polymer layer, a flexible fabric layer, etc.) so that portion 12R can stretch to accommodate movement of supports 38 toward and away from each other to accommodate different user interpupillary distances.

The walls of housing 12 may separate interior region 28 within device 10 from exterior region 30 surrounding device 10. In interior region 28, optical assemblies 20 may be mounted on guide rails 22. Guide rails 22 may be attached to central housing portion 12C. If desired, the outer ends of guide rails 22 may be unsupported (e.g., the outer end portions of rails 22 may not directly contact housing 12, so that these ends float in interior region 28 with respect to housing 12).

Device 10 may include control circuitry 40C and other components such as components 40. Control circuitry 40C may include storage, processing circuitry formed from one or more microprocessors, and/or other circuits. To support communications between device 10 and external equipment, control circuitry 40C may include wireless communications circuitry. The storage in control circuitry 40C may include nonvolatile memory (e.g., flash memory or other electrically-programmable-read-only memory configured to form a solid state drive), volatile memory (e.g., static or dynamic random-access-memory), etc. Processing circuitry in control circuitry 40C may be used to gather input from sensors and other input devices and may be used to control output devices. The processing circuitry in control circuitry 40C may be based on one or more microprocessors, microcontrollers, digital signal processors, baseband processors and other wireless communications circuits, power management units, audio chips, application specific integrated circuits, etc.

Components 40 may include sensors such as such as force sensors (e.g., strain gauges, capacitive force sensors, resistive force sensors, etc.), audio sensors such as microphones, touch and/or proximity sensors such as capacitive sensors, optical sensors such as optical sensors that emit and detect light, ultrasonic sensors, and/or other touch sensors and/or proximity sensors, monochromatic and color ambient light sensors, image sensors, sensors for detecting position, orientation, and/or motion (e.g., accelerometers, magnetic sensors such as compass sensors, gyroscopes, and/or sensors such as inertial measurement units that contain some or all of these sensors), radio-frequency sensors, depth sensors (e.g., structured light sensors and/or depth sensors based on stereo imaging devices), optical sensors such as self-mixing sensors and light detection and ranging (lidar) sensors that gather time-of-flight measurements, humidity sensors, moisture sensors, visual inertial odometry sensors, current sensors, voltage sensors, and/or other sensors. In some arrangements, devices 10 may use sensors to gather user input (e.g., button press input, touch input, etc.). Sensors may also be used in gathering environmental motion (e.g., device motion measurements, temperature measurements, ambient light readings, etc.).

Optical assemblies 20 may have gaze trackers 62 (sometimes referred to as gaze tracker sensors). Gaze trackers 62, which may operate through lenses 34, may include one or more light sources such as infrared light-emitting diodes that emit infrared light to illuminate the eyes of a user in eye boxes 36. Gaze trackers 62 also include infrared cameras for capturing images of the user's eyes and measuring reflections (glints) of infrared light from each of the infrared light sources. By processing these eye images, gaze trackers 62 may track the user's eyes and determine the point-of-gaze of the user. Gaze trackers 62 may also measure the locations of the user's eyes (e.g., the user's eye relief and the user's interpupillary distance).

To accommodate users with different interpupillary distances (eye-to-eye spacings), the spacing between the left and right optical assemblies 20 in device 10 can be adjusted (e.g., to match or nearly match the user's measured interpupillary distance). Device 10 may have left and right actuators (e.g., motors) such as motors 48. Each motor 48 may be used to rotate an elongated threaded shaft (screw) such as shaft 44. A nut 46 is provided on each shaft 44. The nut has threads that engage the threads on that shaft 44. When a shaft is rotated, the nut on the shaft is driven in the +X or −X direction (in accordance with whether the shaft is being rotated clockwise or counterclockwise). In turn, this moves the optical assembly 20 that is attached to the nut in the +X or −X direction along its optical assembly guide rail 22. Each assembly 20 (e.g., support 38) may have portions that receive one of guide rails 22 so that the assembly is guided along the guide rail. By controlling the activity of motors 48, the spacing between the left and right optical assemblies of device 10 can be adjusted to accommodate the interpupillary distance of different users. For example, if a user has closely spaced eyes, assemblies 20 may be moved inwardly (towards each other and towards nose bridge portion NB of housing 12) and if a user has widely spaced eyes, assemblies 20 may be moved outwardly (away from each other).

When device 10 is being worn by a user, the user's head is located in region 68. The presence of the user's head (and therefore a determination of whether device 10 is being worn or is unworn) may be made using one or more sensors (e.g., gaze trackers 62, which may detect the presence of the eyes of the user in eye boxes 36, rear-facing sensors such as sensor 66 on main housing 12M, head-facing sensors mounted on strap 12T such as sensor 64, and/or other head presence sensors). These sensors may include cameras, light sensors (e.g., visible light or infrared sensors that measure when ambient light levels have dropped due to shadowing by the head of a user), proximity sensors (e.g., sensors that emit light such as infrared light and that measure corresponding reflected light from a user's head with an infrared light sensor, capacitive proximity sensors, ultrasonic acoustic proximity sensors, etc.), switches and/or other force-sensing sensors that detect head pressure when a user's head is present, and/or other head presence sensors.

When device 10 is being worn and a user's head is present in region 68, the nose of the user will be present under nose bridge portion NB of housing 12. When optical assemblies 20 are moved towards each other so that assemblies 20 are spaced apart by an amount that matches or nearly matches the user's interpupillary distance, inner side surfaces 60 of support structures 38 in assemblies 20 will move toward opposing outer side surfaces 61 of the user's nose. With sufficient inward movement of assemblies 20, surfaces 60 may get too close to nose surfaces 61, which can lead to reduced field of view and/or compromised display performance. To avoid compromising display performance, device 10 may be provided with features to limit inward nose pressure (e.g., to limit inward force by assemblies 20).

With an illustrative embodiment, whenever device 10 is mounted on the head of a user, motors 48 may only be permitted to move optical assemblies 20 away from each other and not towards each other. This ensures that surfaces 60 will never move towards each other while the user's nose is present, so that the user's nose will never be pressed excessively by moving surfaces 60. Additionally or alternatively, excessively small distances between the user's nose and optical assemblies 20 may be prevented using a model such as a user-specific model that determines whether optical assemblies 20 are appropriately positioned for a particular user's face geometry in real time based on the measured position of the user's pupils relative to optical assemblies 20.

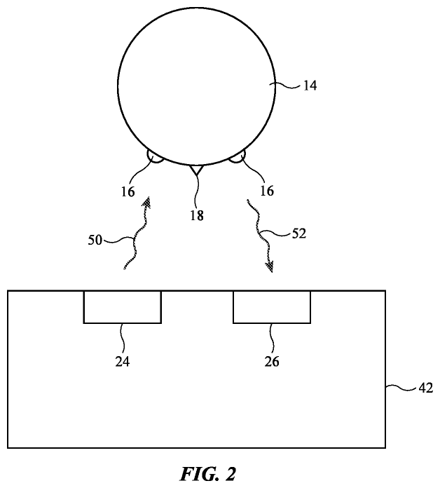

FIG. 2 is a diagram showing how a three-dimensional face scan of the user's face may be captured with a three-dimensional image sensor in device 10 or other electronic device. Image sensor 42 may be a three-dimensional image sensor, camera, and/or other sensor in device 10 and/or in another electronic device such as a cellular telephone, tablet computer, laptop computer, etc. The face scan captured by image sensor 42 may be used to generate a user-specific model that can be used to assess whether optical assemblies 20 are appropriately positioned relative to the user's face during operation of device 10.

In the example of FIG. 2, image sensor 42 includes one or more infrared emitters and one or more infrared detectors that form a three-dimensional depth sensor. Image sensor 42 may be used to produce three-dimensional depth maps such as eye scan information, facial images (e.g., images of a user's face for use in performing facial recognition operations to authenticate the user, images of a user's face and neck for producing Animojis, etc.), and/or other three-dimensional depth mapping information. Image sensor 42 may include infrared light emitter 24 and infrared light detector 26. Image sensor 42 may use infrared light source 24 (e.g., an infrared light-emitting diode, an infrared laser, etc.) to produce infrared light 50. Light 50 may illuminate external objects in the vicinity of image sensor 42 such as the face of user 14 (e.g., may illuminate the eyes 16 and nose 18 of user 14). Reflected infrared light 52 from the face of user 14 may be received and imaged using infrared digital image sensor 26 to produce infrared images (e.g., three-dimensional depth maps) of the user's face including eyes 16 and nose 18.

Infrared light source 24 may operate in different modes depending on the type of infrared information to be gathered by infrared camera 26. For example, in flood illumination mode, light source 24 may emit diffused light that uniformly covers a desired target area. In a structured light mode, light source 24 may emit a known pattern of light onto a desired target area.

In some arrangements, image sensor 42 may be a forward-facing camera in device 10 that is used to capture images (e.g., infrared depth maps and/or visible light images) of the user's environment during use of head-mounted device 10. To capture a face scan in this type of scenario, the user may remove device 10 from the user's head and may point the three-dimensional image sensor 42 (three-dimensional camera) at the user's face. To help ensure that the three-dimensional image sensor is able to capture an accurate three-dimensional image, the three-dimensional image sensor may capture images from different perspectives in front of the user's face (e.g., as the user moves device 10 back and forth in the front of the user's face). The three-dimensional shape (three-dimensional image) of the user's face may be saved in device 10 for subsequent use and/or may be discarded after being used to generate a user-specific model for user 14.

In other arrangements, image sensor 42 may be part of an electronic device that is separate from device 10. For example, image sensor 42 may be part of another device belonging to user 14 such as a cellular telephone or tablet computer, or may be part of a device at a retail store that is used specifically for capturing user face scans during an initial enrollment process (e.g., when a user is purchasing a customized light seal for device 10).

Control circuitry 40C and/or control circuitry in another electronic device may determine a user's face and/or nose geometry based on the face scan captured with image sensor 42. This may include, for example, extracting, interpolating, or calculating one or more data points, values, or dimensions indicative of nose width (e.g., lateral dimensions of the nose at one or more different heights along the nose), nose prominence (e.g., distance with which the nose protrudes outwardly from the face), nose height (e.g., a vertical length of the nose), eye-to-nose distance, brow-to-checkbone distance, eye depth, and/or other dimensions associated with the face and/or nose of the user (e.g., user 14).

In addition to or instead of determining a user's face and nose geometry from a face scan as shown in FIG. 2, a user's face and nose geometry may be inferred based on one or more user studies of typical face and nose geometries. Minimal user information such as eye color, interpupillary distance, and/or other measured user information may be used to help infer the user's face and nose geometry based on these user studies and/or based on other data. As an example, nose geometry may be inferred based on eye color (which may be measured using gaze tracker 62, may be measured by a sensor in a device other than device 10, and/or may be provided directly by the user with user input) using user study data that predicts nose geometry based on eye color. In general, any suitable user information, whether gathered with sensors or provided by the user directly, can be used to make predictions on a user's nose geometry so that an optimal range of optical assembly positions can be determined for that particular user.

After measuring or inferring the specific nose geometry of a given user, control circuitry 40C or control circuitry in a separate electronic device may generate a user-specific model for the user based on that user's face and/or nose geometry. This may include using the face and/or nose geometry in a simulation that simulates different optical assembly positions relative to the user's specific face and nose geometry. Optical assemblies 20 in device 10 may be configured to move along one or more directions (e.g., linearly along the X, Y, and/or Z dimensions of FIG. 1, rotationally about the X-axis of FIG. 1, etc.). Left and right optical assemblies 20 may be configured to move independently of one another (e.g., asymmetrically) or in unison. By simulating different optical assembly adjustments along the X-axis (e.g., to accommodate different interpupillary distances), adjustments along the Y-axis (e.g., to adjust eye relief distance), adjustments along the Z-axis (e.g., how high or low on the face head-mounted device 10 is placed), and/or tilt adjustments about the X-axis (e.g., to accommodate user's with different brow and checkbone geometries), the control circuitry can determine which particular positions of optical assemblies 20 are acceptable (e.g., provide satisfactory display performance and field of view, etc.) and which positions of optical assemblies 20 are unacceptable (e.g., likely to result in unsatisfactory display performance or field of view, etc.).

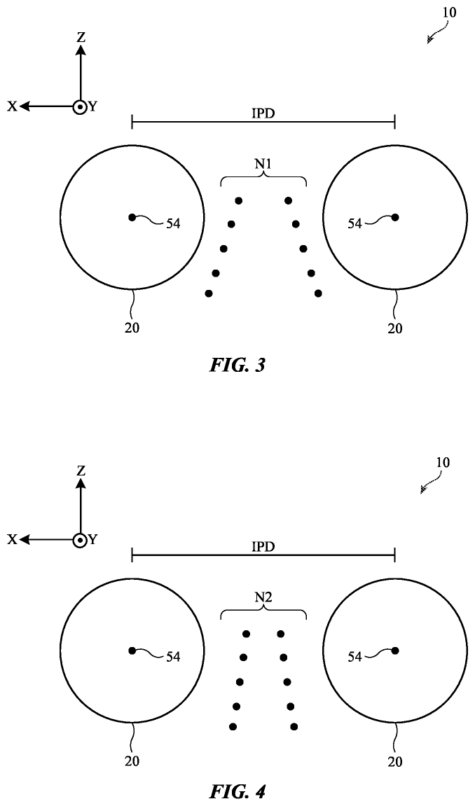

FIGS. 3 and 4 are front views of device 10 illustrating how different nose geometries will have different distances to optical module assemblies 20 for a given optical assembly position.

In the example of FIG. 3, a first set of data points NI represents the nose geometry of a first user. Data points NI may be extracted or otherwise determined from a face scan of the first user's face (e.g., captured with image sensor 42 of FIG. 2) or may be inferred from other information about the user (e.g., eye color, interpupillary distance, hand size, etc.). When the user wears device 10, the user's pupils may be located at pupil positions 54. Pupil positions 54 may be separated by an interpupillary distance IPD. During operation of device 10, interpupillary distance IPD may be measured using gaze tracker 62, may be measured by another sensor, may be inferred based on positions of optical module assemblies 20 (e.g., which may be positioned in response to user input), and/or may otherwise be determined. The positions of optical assemblies 20 along the X-axis may be adjusted to accommodate the user's specific interpupillary distance IPD, and this distance may be a useful indicator for determining a distance between optical assemblies 20 and the outer surfaces of the user's nose (e.g., outer surface 61 of FIG. 1). A simulation can be used to predict when changes in the X-axis positions of optical assemblies 20 is likely to result in excessively small distances between optical assemblies 20 and the first user's nose having a nose geometry represented by data points N1.

In the example of FIG. 4, a second set of data points N2 represents the nose geometry of a second user. Data points N2 may be extracted or otherwise determined from a face scan of the second user's face (e.g., captured with image sensor 42 of FIG. 2) or may be inferred from other information about the user (e.g., eye color, interpupillary distance, hand size, etc.). When the user wears device 10, the user's pupils may be located at pupil positions 54. Pupil positions 54 may be separated by an interpupillary distance IPD. During operation of device 10, interpupillary distance IPD may be measured using gaze tracker 62, may be measured by another sensor, may be inferred based on positions of optical module assemblies 20 (e.g., which may be positioned in response to user input), and/or may otherwise be determined. A simulation can be used to predict when changes in the X-axis positions of optical assemblies 20 (e.g., changes in interpupillary distance IPD) is likely to result in excessively small distances between optical assemblies 20 and the second user's nose having a nose geometry represented by data points N2.

Data points N2 may represent a nose with smaller lateral width dimensions than the nose represented by data points N1. As such, even in arrangements where the interpupillary distance IPD is the same for the first and second users, the first user's nose represented by data points NI may be closer to optical assemblies 20 for a given IPD value. As such, a user-specific model for the first user that is based on nose geometry data points NI may output a smaller distance for the given IPD value of FIG. 3, whereas a user-specific model for the second user that is based on nose geometry data points N2 may output a higher distance for the given IPD value of FIG. 4, even if the two IPD values are equivalent.

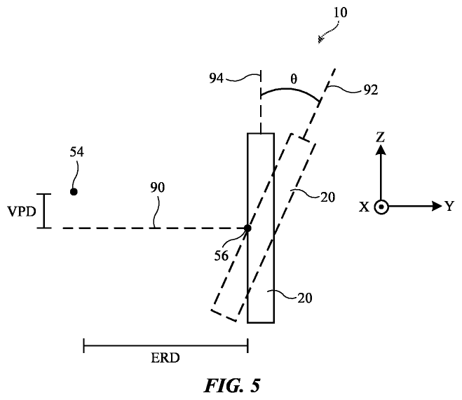

If desired, other measurements and/or dimensions may be taken into account when determining the distance between the user's face and optical assemblies 20. As shown in FIG. 5, the vertical position of pupils 54 relative to optical assembly 20, the eye relief distance between optical assembly 20 and the user's eyes, and the tilt of head-mounted device 10 may play a role in determining whether optical assemblies 20 are appropriately positioned on the user's unique face geometry.

The vertical pupil position VPD refers to the vertical distance along the Z-axis between the user's pupil position 54 and the central optical axis 90 of optical assembly 20. The eye relief distance ERD refers to the horizontal distance along the Y-axis between the user's pupil position 54 and the optical assembly 20. Tilt refers to the angle θ by which optical assembly 20 is rotated about the X-axis (e.g., the angle θ between axis 92 along which optical assembly 20 is aligned and vertical axis 94 which is parallel to the Z-axis of FIG. 5). Vertical pupil position VPD, eye relief distance ERD, and/or tilt angle θ may be measured using gaze tracker 62, may be measured by another sensor (e.g., a motion sensor or inertial measurement unit containing one or more of an accelerometer, gyroscope, and compass), may be inferred based on positions of optical module assemblies 20 (e.g., which may be positioned in response to user input), and/or may otherwise be determined during operation of device 10.

When the user places head-mounted device 10 on the user's head and/or when the user makes adjustments to the placement of head-mounted device 10 on the user's head, there may be resulting changes to the interpupillary distance IPD, vertical pupil position VPD, the eye relief distance ERD, and/or the tilt angle 0. These changes can lead to an increased or decreased distance between the user's face and optical assemblies 20. A nose with larger dimensions (e.g., a nose represented by data points NI of FIG. 3) may be separated from optical assemblies 20 by a smaller distance than a nose with smaller dimensions (e.g., a nose represented by data points N2 of FIG. 4). As such, a user-specific model for a first user that is based on nose geometry data points NI may output a smaller distance for a given pupil position (e.g., a given interpupillary distance IPD, vertical pupil distance VPD, eye relief distance ERD, and tilt angle θ), whereas a user-specific model for a second user that is based on nose geometry data points N2 may output a higher distance for the same pupil position.

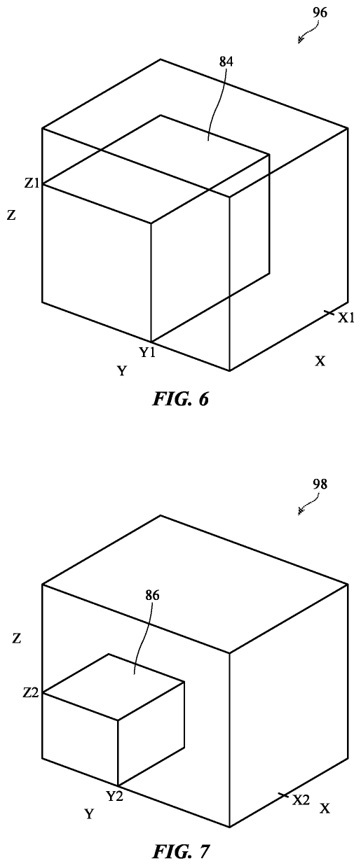

FIGS. 6 and 7 are graphs showing illustrative user-specific models for different users based on the users' unique face and nose geometries. Model 96 of FIG. 6 represents an illustrative user-specific model for a first user having a first nose geometry (e.g., a nose geometry represented by data points NI of FIG. 3). Model 98 of FIG. 7 represents an illustrative user-specific model for a second user having a second nose geometry (e.g., a nose geometry represented by data points N2 of FIG. 4). In the graphs of FIGS. 6 and 7, the X-axis represents the interpupillary distance IPD, the Y-axis represents the eye relief distance ERD, and the Z-axis represents the vertical pupil position VPD. The graphs of FIGS. 6 and 7 are merely illustrative. If desired, the user-specific model may have more than three input variables and/or may have different input variables than the X, Y, and Z values of FIGS. 6 and 7. For example, the user-specific model may have four input variables to also account for the tilt angle θ. The input variables may be measured, inferred, or otherwise determined in real time during operation of device 10 so that the positions of optical assemblies 20 may be assessed in real time.

In the example of FIG. 6, model 96 indicates a zone 84 within which the face of the first user (e.g., having nose geometry data points N1) is deemed to be too close to optical assemblies 20 (e.g., leading to reduced field of view or compromised display performance). Zone 84 may be defined by values X1, Y1, and Z1. X1 represents an interpupillary distance threshold for the first user. Y1 represents an eye relief distance threshold for the first user. Z1 represents a vertical pupil position threshold for the first user. When the user's interpupillary distance IPD is less than X1, eye relief distance ERD is less than Y1, and vertical pupil distance VPD is less than Z1, the first user may be within zone 84 and may be determined to be too close to optical assemblies 20. When the first user's interpupillary distance IPD is greater than X1, eye relief distance ERD is greater than Y1, and vertical pupil distance VPD is greater than Z1, the first user may be outside of zone 84 and may be determined not to be too close to optical assemblies 20.

In the example of FIG. 7, model 98 indicates a zone 86 within which the second user (e.g., having nose geometry data points N2) is deemed to be too close to optical assemblies 20 (e.g., leading to reduced field of view or compromised display performance). Zone 86 may be defined by values X2, Y2, and Z2. X2 represents an interpupillary distance threshold for the second user. Y2 represents an eye relief distance threshold for the second user. Z2 represents a vertical pupil position threshold for the second user. When the user's interpupillary distance IPD is less than X2, eye relief distance ERD is less than Y2, and vertical pupil distance VPD is less than Z2, the user may be within zone 86 and may be determined to be too close to optical assemblies 20. When the user's interpupillary distance IPD is greater than X2, eye relief distance ERD is greater than Y2, and vertical pupil distance VPD is greater than Z2, the user may be outside of zone 84 and may be determined not to be too close to optical assemblies 20.

If desired, each user-specific model may have more than one threshold for each input variable. For example, one or more additional thresholds for each input variable may be used to define one or more different zones with different acceptability levels (e.g., low, medium, and high acceptability zones). The binary zones of FIGS. 6 and 7 (e.g., too close versus not too close to optical assemblies 20) are merely illustrative.

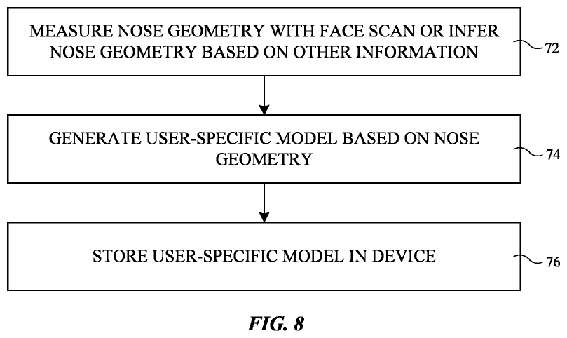

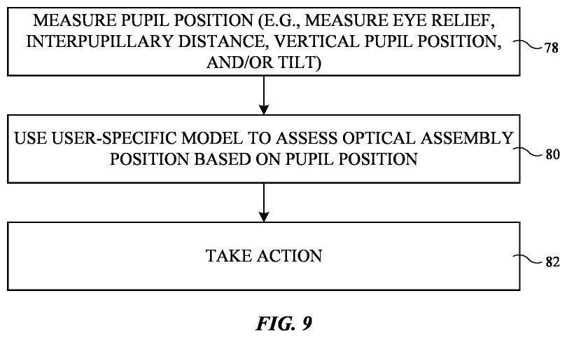

FIG. 8 is a flow chart of illustrative steps involved in storing a user-specific model such as models 96 and 98 of FIGS. 6 and 7.

During the operations of block 72, control circuitry 40C (or control circuitry in a different electronic device) may measure or infer a user's nose geometry. This may include capturing a three-dimensional image of the user's face using three-dimensional image sensor 42 of FIG. 2. Image sensor 42 may be part of head-mounted device 10, may be part of a different electronic device belonging to the user (e.g., a cellular telephone or tablet computer with a facial recognition sensor that can be used to capture three-dimensional images of the user's face) or belonging to a retail store. Image sensor 42 may provide a depth map or other three-dimensional image of the user's face from which nose geometry may be extracted. For example, data points (e.g., data points N1 or N2 of FIGS. 3 and 4) may be extracted or interpolated from the face scan. The data points may indicate one or more nose or face dimensions, such as nose width (e.g., lateral dimensions of the nose at one or more different heights along the nose), nose prominence (e.g., distance with which the nose protrudes outwardly from the face), nose height (e.g., a vertical length of the nose), eye-to-nose distance, brow-to-cheekbone distance, eye depth, and/or other dimensions associated with the face and/or nose of the user. If desired, data from the face images that is not used (or that is used and no longer needed) may be discarded (e.g., may not be stored in device 10).

If desired, the operations of block 72 may include inferring nose geometry (e.g., inferring one or more data points such as data points NI or N2 of FIGS. 3 and 4) based on other information such as eye color, hand size, user demographic information, user input, etc. During the operations of block 74, control circuitry 40C (or control circuitry in a separate electronic device) may generate a user-specific model based on the nose geometry information gathered in block 72. This may include, for example, simulating when display performance is compromised, simulating when field of view is compromised, and/or simulating other scenarios based on the known geometry of head-mounted device 10 and the measured or inferred geometry of the user's nose and face. The simulation may simulate when changes to the positions of optical assemblies 20 relative to the user's unique face shape (e.g., changes in interpupillary distance, eye relief distance, vertical pupil distance, tilt, etc.) are likely to lead to excessively small distances between device 10 and the user's face. Based on this simulation, a user-specific model such as model 96 or 98 may be generated to help map future optical assembly positions to a distance value (a predicted distance between the user's nose and optical assemblies 20) and/or an acceptability level indicating whether the optical assembly positions are acceptable for the particular user's face geometry. The acceptability level may indicate whether the distance between the user's face and the optical assemblies is less than a given threshold distance (e.g., zero or a non-zero threshold distance). For example, a “not acceptable” optical assembly position may indicate that the distance between optical assemblies 20 and the user's face is less than a threshold (e.g., the optical assemblies 20 are too close to the face), whereas an “acceptable” optical assembly position may indicate that the distance between optical assemblies 20 and the user's face is greater than a threshold (e.g., the optical assemblies 20 are far enough away from the user's face to avoid compromised field of view).

During the operations of block 76, control circuitry 40C may store the user-specific model. If desired, the user-specific model may be stored in a user profile that is associated with a particular user. The user may be authenticated with biometric information such as an iris scan captured with gaze tracker 62. Biometric information such as the iris scan may be stored in the user profile with the user-specific model. In this way, whenever the user starts using head-mounted device 10 and is authenticated using an iris scan, control circuitry 40C can use the user-specific model in that user's user profile to assess whether optical assemblies 20 are appropriately positioned relative to the user's face during the user's session with device 10.

FIG. 9 is a flow chart of illustrative steps involved in using a user-specific model to determine the distance between the user's face and optical assemblies 20 and/or to determine whether optical assemblies 20 are appropriately positioned during operation of device 10.

During the operations of block 78, control circuitry 42 may gather pupil position information using one or more sensors in device 10 such as gaze tracker 62. This may include, for example, measuring interpupillary distance IPD (FIGS. 3 and 4), eye relief distance ERD (FIG. 5), and vertical pupil distance VPD (FIG. 5) using gaze tracker 62. If desired, tilt angle 0 (FIG. 5) may also be measured (e.g., using an inertial measurement unit, gaze tracker 62, or other sensor).

During the operations of block 80, control circuitry 40 may feed the input variables gathered during block 78 into the user-specific model stored in device 10. This may include, for example, using the user-specific model for the particular user wearing device 10 to map the pupil position information (e.g., pupil positions in X, Y, and Z relative optical assemblies 20) to a distance value (e.g., a predicted distance between optical assemblies 20 and the user's face) and/or an acceptability value (e.g., whether the position of optical assemblies 20 is acceptable). The distance value and/or acceptability value may be a binary value (e.g., distance is too small or not too small, position is acceptable or not acceptable, etc.) or may be one of more than two options (e.g., distance is less than threshold but within tolerance, distance is less than threshold and not within tolerance, or distance is greater than threshold).

The acceptability level may indicate whether the distance between the user's face and the optical assemblies is less than a given threshold distance (e.g., zero or a non-zero threshold distance). For example, a “not acceptable” optical assembly position may indicate that the distance between optical assemblies 20 and the user's face is less than a threshold (e.g., the optical assemblies 20 are too close to the face), whereas an “acceptable” optical assembly position may indicate that the distance between optical assemblies 20 and the user's face is greater than a threshold (e.g., the optical assemblies 20 are far enough away from the user's face to avoid a compromised field of view).

During the operations of block 82, control circuitry 40C may take action in response to the determined distance value and/or acceptability level. If the distance is greater than a threshold (e.g., greater than zero or greater than some other threshold) and/or if the position is deemed to be acceptable, control circuitry 40C may continue to monitor sensors (e.g., gaze tracking sensor 62, an inertial measurement unit, etc.) to determine when the optical assembly position should be assessed again, or control circuitry 40C may continue to assess optical assembly positions at regular intervals. If the distance is less than the threshold and/or if the position is deemed to be unacceptable, control circuitry 40C may output an alert (e.g., an audible alert from a speaker, a visual alert from a display or other light source, a haptic alert, etc.), may output instructions to insert a shim to increase eye relief distance, may output instructions to change light seals, may output instructions to adjust the placement of head-mounted device 10 on the user's head and/or to adjust optical assemblies 20, may prevent further movement of optical assemblies 20, may reverse a previous position adjustment to optical assemblies 20, and/or may take other suitable actions.

The foregoing is merely illustrative and various modifications can be made to the described embodiments. The foregoing embodiments may be implemented individually or in any combination.

What is claimed is:

1. A head-mounted device configured to be worn by a user, the head-mounted device comprising:
a head-mounted housing;
optical assemblies in the head-mounted housing that are movable relative to one another;
a gaze tracker configured to measure pupil position information; and
control circuitry that stores a user-specific model and that is configured to use the user-specific model to determine a distance between the optical assemblies and a face of the user based on the measured pupil position information.

2. The head-mounted device defined in claim 1 wherein the measured pupil position information comprises an interpupillary distance value along a first axis, an eye relief distance value along a second axis, and a vertical pupil distance value along a third axis.

3. The head-mounted device defined in claim 2 wherein the first axis, the second axis, and the third axis are orthogonal to one another.

4. The head-mounted device defined in claim 2 further comprising a motion sensor that measures a tilt angle indicating an amount by which the optical assemblies are rotated about the first axis, wherein the distance is determined based on the tilt angle.

5. The head-mounted device defined in claim 2 wherein the user-specific model maps the interpupillary distance value, the eye relief distance value, and the vertical pupil distance value to an acceptability level indicating whether the distance is less than a threshold distance.

6. The head-mounted device defined in claim 1 wherein the control circuitry is configured to take action in response to determining the distance and wherein the action is selected from the group consisting of: outputting an alert, outputting instructions to adjust the head-mounted device, disabling movement of the optical assemblies, and reversing a previous adjustment to positions of the optical assemblies.

7. The head-mounted device defined in claim 1 wherein the user-specific model is based on a face scan.

8. The head-mounted device defined in claim 7 further comprising a forward-facing three-dimensional camera configured to capture the face scan.

9. The head-mounted device defined in claim 1 wherein the gaze tracker is configured to capture an iris scan associated with a given user profile and wherein the user-specific model is stored in the user profile with the iris scan.

10. The head-mounted device defined in claim 1 wherein the user-specific model is based on an inferred nose geometry.

11. The head-mounted device defined in claim 1 wherein the gaze tracker comprises infrared light-emitting diodes and an infrared camera.

12. A head-mounted device configured to be worn by a user, the head-mounted device comprising:
a head-mounted housing;
a forward-facing camera configured to capture a face scan;
control circuitry configured to extract nose geometry from the face scan;
an optical assembly in the head-mounted housing; and
a gaze tracker configured to measure pupil position, wherein the control circuitry is configured to determine a distance between the optical assembly and a face of the user based on the nose geometry and the pupil position.

13. The head-mounted device defined in claim 12 wherein the forward-facing camera comprises a three-dimensional camera and the face scan comprises a three-dimensional face image.

14. The head-mounted device defined in claim 12 wherein the control circuitry is configured to store a user-specific model that predicts the distance based on the nose geometry and the pupil position.

15. The head-mounted device defined in claim 14 wherein the gaze tracker is configured to capture an iris scan associated with a user profile and wherein the user-specific model is stored in the user profile with the iris scan.

16. A method for operating a head-mounted device that is configured to be worn by a user, wherein the head-mounted device comprises optical assemblies, a gaze tracker, and control circuitry, the method comprising:
with the gaze tracker, measuring a pupil position;
with the control circuitry, using a stored user-specific model to determine a distance between the optical assemblies and a face of the user based on the pupil position; and
with the control circuitry, adjusting an operation of the head-mounted device based on the distance.

17. The method defined in claim 16 wherein measuring the pupil position comprises measuring interpupillary distance along a first axis, eye relief distance along a second axis, and vertical pupil distance along a third axis.

18. The method defined in claim 16 wherein adjusting the operation of the head-mounted device comprises outputting instructions for the user to make an adjustment to the head-mounted device.

19. The method defined in claim 16 wherein adjusting the operation of the head-mounted device comprises disabling further movement of the optical assemblies.

20. The method defined in claim 16 wherein adjusting the operation of the head-mounted device comprises reversing at least part of a previous adjustment to positions of the optical assemblies.
